(19) United States
(12) Patent Application Publication
(10) Pub. No.: US 2007/0231117 A1
(43) Pub. Date: Oct. 4, 2007

(54) Two-way generation tidal power plant with one-way turbines

(76) Inventor: Alexander Gokhman, San Francisco, CA (US)

Correspondence Address: ALEXANDER GOKHMAN, 3031 NORIEGA STREET, SAN FRANCISCO, CA, 94122, US

(21) Appl. No.: 11/395,967

(22) Filed: Apr. 3, 2006

(51) Int. Cl. F03B 15/06

(52) U.S. Cl. 415/2.1

(57) ABSTRACT

The invention is a two-way generation tidal power plant with one-way turbines. The purpose of the invention is to have a two-way generation tidal power plant with the same high efficiency for both ebb and flood generations. In order to achieve this, additional head and tail reservoirs for a power house are formed by additional barrages in the basin and the outer bay. During flood generation the head reservoir is connected to the outer bay and the tail reservoir is connected to the basin. During ebb generation, the head reservoir is connected to the basin and the tail reservoir is connected to the outer bay.

### BACKGROUND OF THE INVENTION

This invention relates to tidal power plants. More specifically, the invention relates to two-way generation tidal power plants with a barrage. The barrage separates the basin from the rest of bay (outer bay).

Any tidal power plant with a barrage has a power house with hydraulic turbines and electric generators. The power house itself is a part of the barrage. If the hydraulic turbines can work with flow passing in both directions, then the plant generates power during high tide with water passing through the turbines to the basin and during low tide with the water passing from the basin to the outer bay (two-way generation). If the hydraulic turbines can work with the flow passing in only one direction the tidal power plant generates power either during high tide (flood generation) or during low tide (ebb generation), but not both.

Power output of a tidal power plant turbine Pₜ (kW) is given by the following formula:
Pₜ=gηQₜHₜ (1)
where:
ηₜ is the efficiency of the turbine,
Hₜ is the turbine head (m),
Qₜ is the flow rate through the turbine (m³/sec), and
g is gravitational acceleration (g=9.81 m/sec²).

A two-way generation tidal power plant is clearly more attractive, because potentially it could produce twice the energy than either ebb generation or flood generation plants using the same barrage. Current technology offers only two possible scenarios:

Case 1: Tidal power plant turbines similar to those normally used for a low head hydro electric plant.

Such turbines have adjustable blade runners and diagonal wicket gates. However, in a two-way generation tidal power plant the turbines must work with flow moving in both directions, so their blades must rotate through the range of angles between optimum positions for opposite flow directions. This range may even exceed 180°, though for conventional adjustable blade runners the range is bounded above by 50°. This makes two-way runners more expensive and less reliable.

The efficiency of this kind of two-way turbine is not the same for each direction. If the turbine is designed to work with high efficiency, say around 90%, in one direction, then it exhibits much lower efficiency in the other direction.

One example of deployment of such turbines, is the largest operating tidal power plant in La Rance, France, with adjustable blade runners and peak power of Pₚ=240 MW. It is equipped with ALSTOM bulb turbines originally designed and built for two-way generation. However, due to mechanical problems they allow only ebb generation.

Case 2: Orthogonal tidal power plant turbines, similar to Darrieus turbines for wind power plants (an experimental section of a power house with an orthogonal turbine with diameter 2.5 m is being constructed at Kislaya Guba, Russia).

These turbines have the same efficiency in both directions, however it is about 65%. Also they rotate very slowly and can work only with direct current generators. Thus, such turbines require the installation of converters from direct to alternating current. The use of converters decreases the overall efficiency of the plant and increases the cost of equipment.

In either case, two-way tidal power generation with barrage presents a need for an economically attractive technical solution.

### BRIEF SUMMARY OF THE INVENTION

The present invention discloses a two-way generation tidal power plant with a barrage in which the water flow moves through the hydraulic turbines in the same direction for both ebb and flood generation. In oder to maintain the same flow direction in the turbines for ebb and flood generation, the tidal power plant has two additional barrages separating its power house from the basin and the outer bay. These two additional barrages form the head and tail reservoirs for the power house. Each reservoir can be connected to the basin and the outer bay by means of sluices with gates. During ebb the head reservoir is connected to the basin and the tail reservoir is connected to the outer bay. During flood the head reservoir is connected to the outer bay and the tail reservoir is connected to the basin. There are two possible arrangements for the head and tail reservoirs. In one arrangement the head reservoir is located in the outer bay and the tail reservoir in the basin. In the alternative arrangement the head reservoir is located in the basin and the tail reservoir in the outer bay.

The power house is the same as in a conventional low head hydro power plant and can be fitted with conventional bulb turbines with the electrical generator located in the bulb. The turbine runner could be a Kaplan runner or an axial propeller. An ideal turbine for such a power house would be a bulb turbine with an axial propeller and an exit stay apparatus (see Hydraulic Trbine and Exit Stay Apparatus therefor, U.S. Pat. No. 6,918,744 B2, Jul. 19, 2005). A bulb turbine with an axial propeller and an exit stay apparatus has almost the same overall efficiency as a bulb turbine with a Kaplan runner, but is more reliable, less expensive, and fish friendly.

A two-way generation tidal power plant with one-way turbines and with head and tail reservoirs is the most advantageous economically in the case of a tidal power plant with a barrage much longer than the power house. In this case the construction of two additional barrages forming the reservoirs will increase the cost of the plant construction much less than by a factor of two compared to a one-way generation plant, whereas the yearly energy production will increase two-fold and the time to recoup the capital will substantially decrease. The proposed tidal power plant for Fundy bay is the best application for a two-way generation tidal power plant with one-way turbines and with head and tail reservoirs, since its total length from shore to shore is 7.91 km and the power house length (along the barrage) is only 2.34 km.

### BRIEF DESCRIPTION OF THE SEVERAL VIEWS OF THE DRAWINGS

FIG. 1 is a plan view of a two-way generation tidal power plant with one-way turbines which has a main barrage and two additional barrages forming the head reservoir in the outer bay and the tail reservoirs in the basin;

FIG. 2 is a plan view of a power house with two additional barrages of a two-way generation tidal power plant with one-way turbines during the flood when the head reservoir is connected to the outer bay and the tail reservoir is connected to the basin;

FIG. 3 is a plan view of a power house with two additional barrages of a two-way generation tidal power plant with one-way turbines during the web when the head reservoir is connected to the basin and the tail reservoir is connected to the outer bay;

FIG. 4 is an elevation view, partially in cross-section of a power house of a two-way generation tidal power plant with one-way turbines.

### DETAILED DESCRIPTION OF THE INVENTION

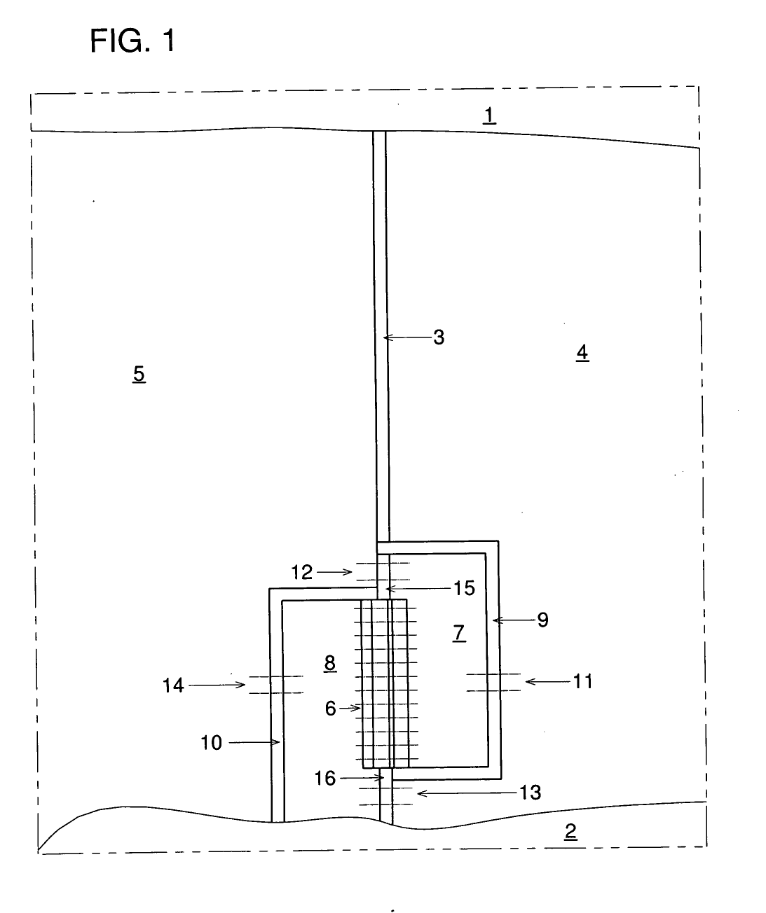

Referring now to FIG. 1, a two-way generation tidal power plant with one-way turbines having a main barrage and two additional barrages forming the head reservoir in the outer bay and the tail reservoirs in the basin is shown. The tidal power plant comprises a main barrage 3 and a power house 6 between bay shores 1 and 2. A power house 6 is located at the shore 2. A head reservoir 8 is formed by a head barrage 10 located in the outer bay 5, a power house 6, a part of a main barrage 16 located between a power house 6 and the shore 2, and the shore 2 between a head barrage 10 and a part of a main barrage 16. A tail reservoir 7 is formed by a tail barrage 9 located in the basin 4, a power house 6, and a part of a main barrage 15 located between a power house 6 and a tail barrage 9. There are sluices 14 connecting a head reservoir 8 with the the outer bay 5 and sluices 13 connecting a head reservoir 8 with the basin 4. There are also sluices 12 connecting a tail reservoir 7 with the outer bay 5 and sluices 11 connecting a tail reservoir 7 with the basin 4.

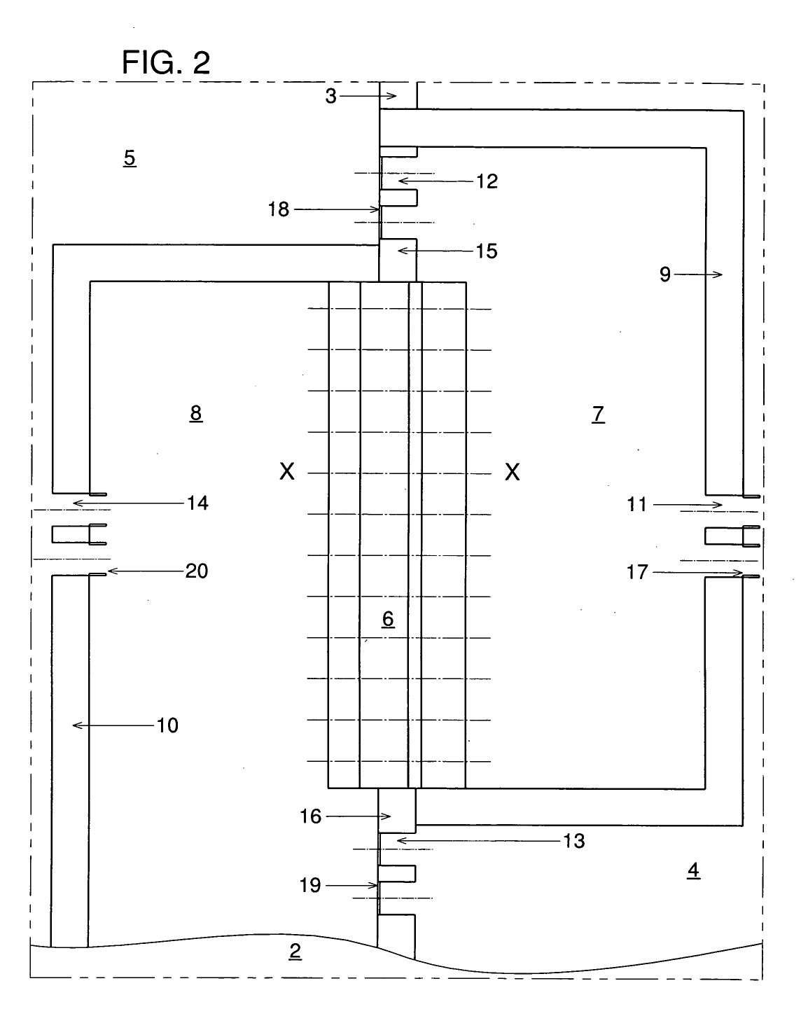

FIG. 2 shows a power house 6 with a head reservoir 8 and a tail reservoir 7 of the tidal power presented in FIG. 1 during the flood when a head reservoir 8 is connected with outer bay 5 and a tail reservoir 7 is connected with basin 4. In order to provide such an arrangement gates 20 of sluices 14 in head barrage are open, gates 19 of sluices 13 in a part of a main barrage 16 between power house 6 and the shore 2 are closed, gates 17 of sluices 11 in tail barrage are open, and gates 18 of sluices 12 in a part of a main barrage 15 between power house 6 and a tail barrage 9 are closed.

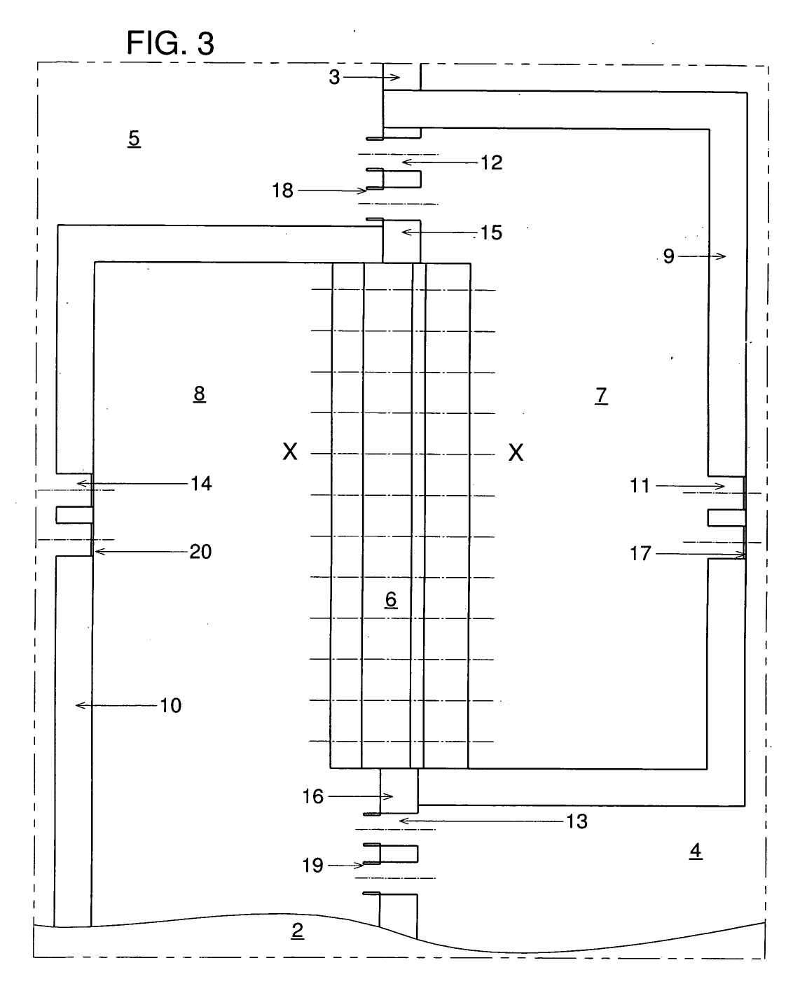

FIG. 3 shows a power house 6 with a head reservoir 8 and a tail reservoir 7 of the tidal power presented in FIG. 1 during the web when a head reservoir 8 is connected with basin 4 and a tail reservoir 7 is connected with outer bay 5. In order to provide such an arrangement gates 20 of sluices 14 in head barrage are closed, gates 19 of sluices 13 in a part of a main barrage 16 between power house 6 and the shore 2 are open, gates 17 of sluices 11 in tail barrage are closed, and gates 18 of sluices 12 in a part of a main barrage 15 between power house 6 and a tail barrage 9 are open.

Sluices 11, 12, 13 and 14 shown in FIGS. 1, 2, and 3 must have openings with a sufficient area in order not to cause the significant loss of tidal power plant turbine head, Hₜ.

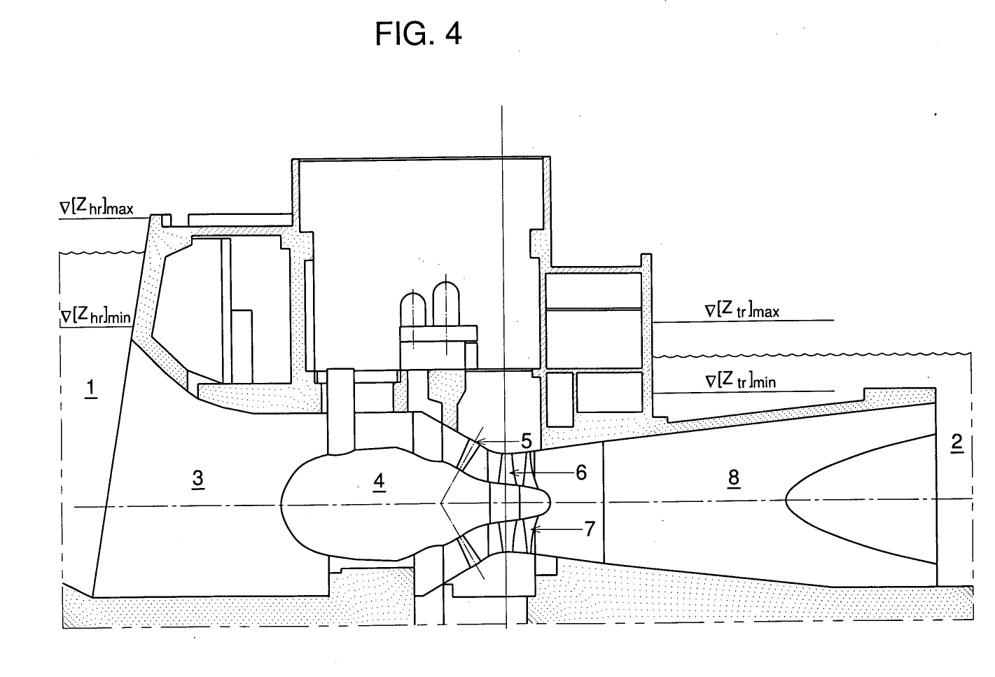

FIG. 4 shows a cross-section of a power house 6 by a vertical plane X-X passing through a power plant turbine in FIGS. 2 and 3. As can be seen in FIG. 4 the house 6 is a conventional power house of a low head river hydro electric plant with a bulb hydraulic turbine (see H. Brekke, Hydro Machines, Lecture compendium at NTHU, Trondheim, 1992).

A bulb hydraulic turbine presented in FIG. 4 has an intake 3 connected with head reservoir 1, a bulb 4 with electrical generator inside, a wicket gate apparatus 5, an axial propeller runner 6, an exit stay apparatus 7, and a draft tube 8 connected with tail reservoir 2.

FIG. 4 also shows maximum and minimum water levels for the head and tail reservoirs:
[Zₕᵣ]ₘₐₓ—the head reservoir maximum level,
[Zₕᵣ]ₘᵢₙ—the head reservoir minimum level,
[Zₜᵣ]ₘₐₓ—the tail reservoir maximum level, and
[Zₜᵣ]ₘᵢₙ—the tail reservoir minimum level,

When the head reservoir level is equal to [Zₕᵣ]ₘᵢₙ and the tail reservoir level is equal to [Zₜᵣ]ₘₐₓ the sluice gates 17, 18, 19, and 20 of FIGS. 3 and 4 switch the connections of head and tail reservoirs with the basin and outer bay.

Due to the fact that in the power house of a two-way generation tidal power plant with head and tail reservoirs the water flows in the same direction during both web and flood generations, it can be fitted with one-way conventional bulb turbines and electrical generators located in the bulbs. The turbine runner could be a Kaplan runner or an axial propeller. An ideal turbine for such a power house is a bulb turbine with an axial propeller and an exit stay apparatus (see Hydraulic Turbine and Exit Stay Apparatus therefor, U.S. Pat. No. 6,918,744 B2, Jul. 19, 2005). A bulb turbine with an axial propeller and an exit stay apparatus has almost the same overall efficiency as a bulb turbine with a Kaplan runner, but it is more reliable, less expensive, and fish friendly. A bulb turbine with an axial propeller without an exit stay apparatus can be used only with direct current electrical generators, because otherwise it has low overall efficiency and high pulsations in the draft tube.

A two-way generation tidal power plant with one-way turbines presented in FIGS. 1, 2, 3, and 4 clearly will produce twice more energy than an ebb or a flood generation tidal power plant build on the same site. The cost of construction for this kind of two-way generation plant is higher than the cost of an ebb or a flood generation tidal plant, because of the additional cost for the head and tail barrages. However, this two-way generation tidal power plant with one-way turbines and with head and tail reservoirs is the most advantageous economically in the case of tidal power plant with barrage much longer than the power house. In this case the construction of two additional barrages forming these reservoirs will increase the cost of the plant construction much less than by a factor of two compared to a one-way generation plant, whereas the yearly energy production will increase two-fold and the time to recoup the capital will substantially decrease. The proposed tidal power plant for Fundy bay is the best application for a two-way generation tidal power plant with one-way turbines and with additional barrages, since its total length from shore to shore is 7.91 km and the power house length (along the barrage) is only 2.34 km.

I claim:

1. A two-way generation tidal power plant having a main barrage, a power house with hydraulic turbines connected to electrical generators;
said main barrage and said power house dividing the bay into basin and outer bay;
and said hydraulic turbines having the water flowing in the same direction during both ebb and flood generations.

2. A two-way generation tidal power plant of claim 1 comprising additional head and tail barrages;
said head barrage forming together with said power house and said main barrage a head reservoir;
said tail barrage forming together with said power house and said main barrage a tail reservoir.

3. A two-way generation tidal power plant of claim 2 comprising sluices with gates located in said main, head, and tail barrages;
said sluices connecting said head reservoir with said basin and said tail reservoir with said outer bay during ebb generation;
and said sluices connecting said head reservoir with said outer bay and said tail reservoir with said basin during flood generation;

4. A two-way generation tidal power plant of claim 3 wherein said hydraulic turbines are bulb turbines having intake, guide gate apparatus, runner apparatus, and draft tube.

5. A two-way generation tidal power plant of claim 4 wherein said runner apparatus is an axial flow adjustable blade runner.

6. A two-way generation tidal power plant of claim 4 wherein said runner apparatus is an axial flow propeller runner;

7. A two-way generation tidal power plant of claim 6 wherein said bulb turbines have exit stay apparatus located in said draft tube after said runner apparatus.
